(19) United States
(12) Patent Application Publication
(10) Pub. No.: US 2002/0099597 A1
(43) Pub. Date: Jul. 25, 2002

(54) Method for analyzing assortment of retail product

(76) Inventors: Michael Gamage, Aurora, CO (US); Pat Conzet, Grover, MO (US); Paul Warnicke, Portage, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/035,731

(22) Filed: Dec. 26, 2001

Related U.S. Application Data
(60) Provisional application No. 60/258,470, filed on Dec. 27, 2000.

(51) Int. Cl. G06F 17/60

(52) U.S. Cl. 705/10

(57) ABSTRACT

The present invention discloses computer-based method for determining a product mix for a retail store. The product mix represents the varieties of products, services or other commodities offered by a retailer. Each product or service further represents a particular market segment. The method of the present invention allows each market segment to be evaluated by a retailer in order to determine the optimum product mix for maximizing sales.

### CROSS-REFERENCE TO RELATED APPLICATIONS

This application claims the benefit of U.S. Provisional Patent Application Serial No. 60/258,470, filed Dec. 27, 2000.

### FIELD OF THE INVENTION

This invention relates generally to a method of determining a product mix for a retail store, and more particularly, to a method of determining a product mix for a retail store using information from more than one source and generating reports.

### BACKGROUND OF THE INVENTION

Product within a retail store has proven to be a large factor in retail sales. However, the ideal product mix in a retail store for optimum sales of a particular product market, segment or sub-segment or in general may be a trial and error process.

With the use of universal product codes (“UPC”) and sophisticated scanning and register systems, large amounts of data concerning consumer shopping habits and sales are available. Consumer purchasing data is also available from many other sources such as research groups and public surveys which provide syndicated data for purchase. Examples of such sources of syndicated data are Information Resources Incorporated (“IRI”) and A. C. Nielsen (“ACN”). In addition, planogram data, or the products currently stocked in a retail store, may also be available.

Typically, the data is manipulated by hand through several iterative calculations by manufacturers and/or suppliers to provide useful information, in a useable format to retailers, such as the products that consumers are currently purchasing and demographic information demonstrating trends that are occurring within a particular marketplace that retailers and consumers may take advantage of.

As a consequence of the vast amounts of data available, manual manipulation of such data to determine the proper product mix in a retail store for optimizing sales has been a laborious and inefficient process.

The present invention is aimed at solving one or more of the problems identified above.

### SUMMARY OF THE INVENTION AND ADVANTAGES

In one aspect of the present invention, a computer-based method for determining a product mix for a retail store is disclosed. The method includes the steps of establishing a market segment and a market cutoff rate, and generating a list of suggested product mix as a function of the market segment, the market cutoff rate and a sales information database.

In another aspect of the invention, a computer-based method for determining a product mix for a retail store is disclosed. The method includes the steps of establishing a market segment and a market cutoff rate and generating a list of suggested product mix as a function of the market segment, the market cutoff rate and a sales information database. The method further includes the steps of determining an opportunity gap as a function of the sales information database and producing a report.

In yet another aspect of the present invention, a computer-based method for determining a product mix for a retail store is disclosed. The method includes the steps of establishing a market segment, a market cutoff rate, a sales information database and marketing conditions and generating segment worksheets as a function of the sales information database, the market segment and the market cutoff rate. The method further includes the steps of generating a list of suggested product mix as a function of the market segment, the market cutoff rate, the sales information database, and the marketing conditions, determining an opportunity gap as a function of the sales information database, and producing a report including the list of suggested product mix.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1A is a flow diagram of a computer-based method of producing reports for product mix for a retail store, according to an embodiment of the present invention;

FIG. 1B is a flow diagram of a computer-based method of producing reports for product mix for a retail store, according to an embodiment of the present invention;

FIG. 1C is a flow diagram of a computer-based method of producing reports for product mix for a retail store, according to an embodiment of the present invention.

FIG. 2 is a diagrammatical illustration of an initial dialog box of a computer program embodying the present invention;

FIGS. 3 is a diagrammatical illustration of a dialog box including an Excel folder having several sales information databases, according to an embodiment of the present invention;

FIG. 4 is a diagrammatical illustration of a sales information database having account data, according to an embodiment of the present invention;

FIG. 5 is a diagrammatical illustration of a dialog box for inputting the market cutoff rate, according to an embodiment of the present invention;

FIG. 6 is a diagraimmatical illustration of a dialog box for selecting segmentation data, according to an embodiment of the present invention;

FIG. 7 is a diagrammatical illustration of a dialog box for entering an ACV value to be used for determining the opportunity gap, according to an embodiment of the present invention;

FIG. 8 is a diagrammatical illustration of a dialog box for producing reports, according to an embodiment of the present invention;

FIG. 9 is a diagrammatical illustration of an account worksheet, according to an embodiment of the present invention;

FIG. 10 is a diagrammatical illustration of an account worksheet, according to an embodiment of the present invention;

FIG. 11 is a diagrammatical illustration of a category worksheet, according to an embodiment of the present invention;

FIG. 12 is a diagrammatical illustration of a category worksheet, according to an embodiment of the present invention;

FIG. 13 is a diagrammatical illustration of a dialog box for changing an assortment, according to an embodiment of the present invention;

FIG. 14 is a diagrammatical illustration of an impact report, according to an embodiment of the present invention;

FIG. 15 is a diagiammatical illustration of a new assortment report, according to an embodiment of the present invention; and

FIG. 16 is a diagrammatical illustration of a top-bottom report, according to an embodiment of the present invention.

### DETAILED DESCRIPTION OF THE PREFERRED EMBODIMENT

Referring to the Figures, wherein like numerals indicate like or corresponding parts throughout the several views, a computer-based method for determining a product mix for a retail store according to an embodiment of the present invention is generally shown at 100. The product mix represents the varieties of products, services or other commodities offered by a retailer. Each product or service further represents a particular market segment. The method of the present invention allows each market segment to be evaluated by a retailer in order to determine the optimum product mix for maximizing sales. Examples of a market segments may be cereal, pickles, rice, pasta, vegetables, and so on.

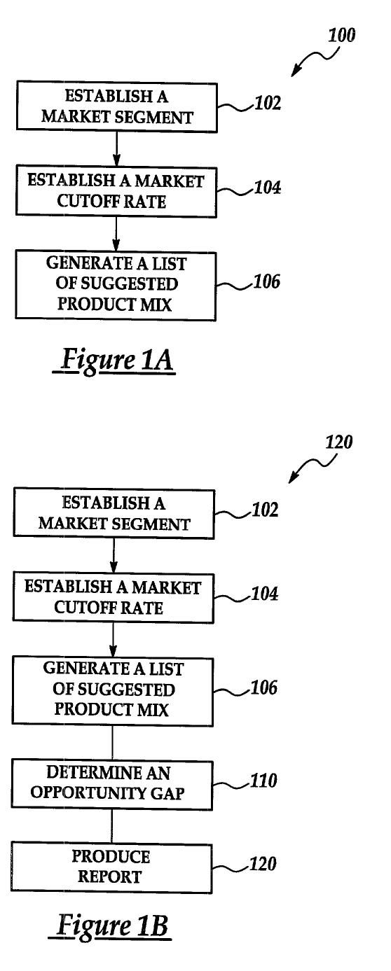

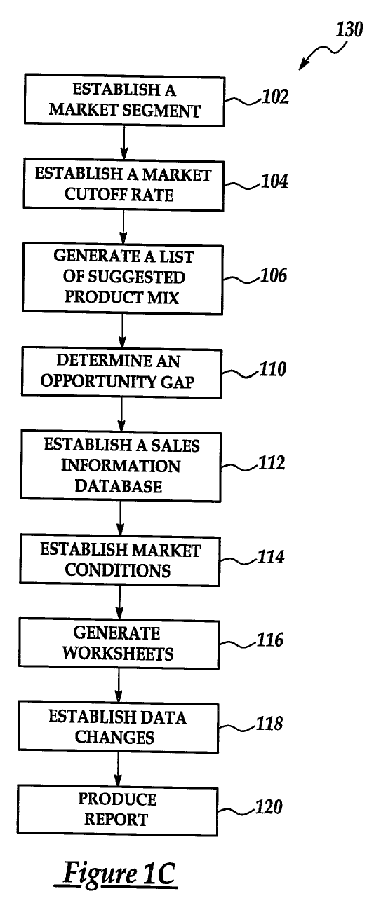

With particular reference to FIG. 1A, a method for determining a product mix for a retail store, according to a first embodiment of the present invention will now be discussed. In a first control block 102, the method 100 includes the step of establishing a market segment. Establishing includes reading, identifying, storing, inputting as a function of input by a user or any other suitable method of receiving or reading data. The market segment represents a product, a service or any other suitable consumer demand in a marketplace. A retailer chooses a market segment in accordance with the product, service or other commodity offered by the retailer in order to evaluate the current success of the retail store and the potential success according to the existing market segment provided by the retailer. Furthermore, a market segment may include categories such as ready-to-eat cereal, cooked cereal, canned vegetables, milk, cheese or any other category, segments such as adult, all-family and kid cereals, and sub-segments such as adult fruit-and-nut, adult wholesome and adult raisin bran cereals. The example discussed herein pertains to cereal products. However, the method 100 is not to be read as limited in any way to cereal.

In a second control block 104, the method 100 of the present invention further includes the step of establishing a market cutoff rate. The market cutoff rate represents a percentage of a market distribution for a particular market segment that a retailer wishes to provide. For example, of all types of cereals available on the market, or market distribution, the cereals made available for purchase at a retail store represents the percentage of market distribution. Thus, the market cutoff rate may be a percentage, a cumulative dollar sales or any other suitable representation of an amount determined by the retailer representing the amount of the market distribution the retailer wishes to make available at the retail store. While a retailer may want to carry 90 percent of the market distribution for cereals at the retail store, they may only want to carry 60 percent of the market distribution for pickles. Other applicable depictions of portion of sales, loss or suitable field of measurement may also be used.

In a third control block 106, a list of suggested product mix is generated as a function of the market segment, the market cutoff rate and a sales information database having information related to sales of product as a function of time. A sales information database is generated by inputting data from files which may exist in the computer program or files that may be imported into the computer program or worksheets that may be generated by the computer program.

The sales information database may include syndicated data and consumer panel data such as IRI data, ACN data or any other suitable data that may be purchased from a source which compiles scan data, such as UPC data, purchased from retailers.

The sales information database may further include planogram data in text, graphical or any other suitable format representing the market distribution carried by the retail store. The planogram data included may represent a single market segment or more than one market segment carried by the retail store. Incorporating planogram data allows retailer to determine what products in the market segment their retail store account is carrying and provides information regarding products and services not carried that may be selling better.

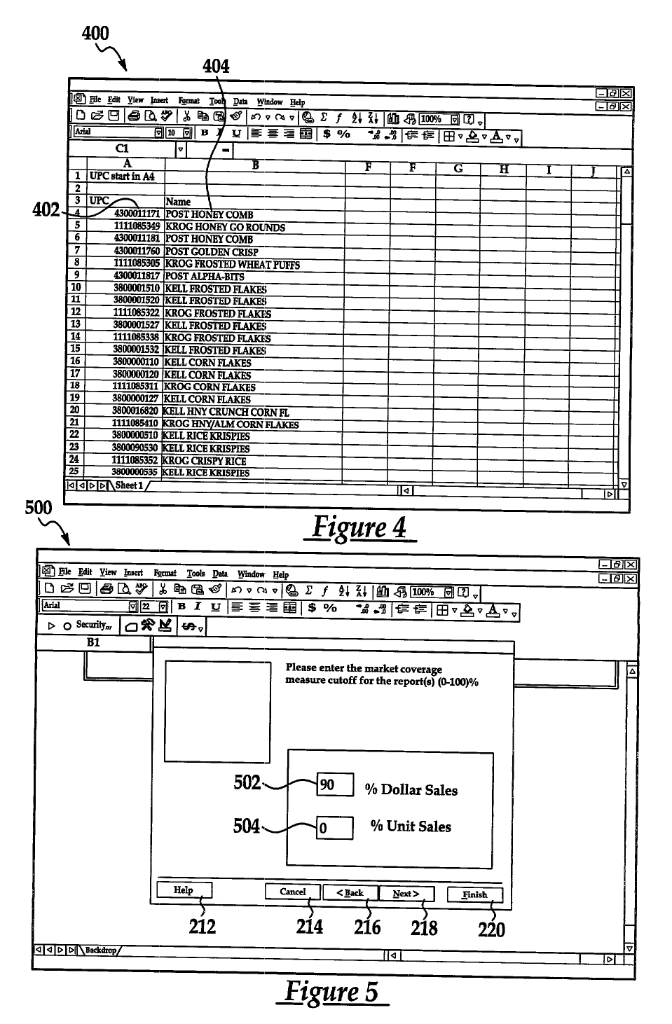

The sales information database may further include account data associated with the retail store. Referring to FIG. 4 in one embodiment, the account data is stored in a spreadsheet 400 comprising the account information is shown. The account data may include account information associated with the retail store such as an identifier 402, description data 404, dollar sales data or any other suitable account data. An example of the identifier 402 may be a UPC 402 or any other suitable identifier associated with a product or service. The retail store account data may further include all commodity volume (“ACV”) weighted distribution data and dollars per million ACV data. ACV data represents the entire volume of product or service sold by a retailer. The ACV weighted distribution data is the percent of the ACV that represents a product or service. Similarly, the dollars per million ACV data represents the dollar amount of a product or service per million dollars of total volume sold.

Retail store account data may further include segmentation data wherein the products or services are broken down into a hierarchy of levels. For example, the products or services provided in the retail store may be divided as segmentation data into category data or unit sales, segment data or class, and sub-segment data or sub-class. The category data may be ready-to-eat cereal, cooked cereal, canned vegetables, milk, cheese or any other category. The segment data are the categories further divided into segments such as adult, all-family and kid cereals. The sub-segment data 608 are the segments further divided into sub-segments such as adult fruit-and-nut, adult wholesome and adult raisin bran cereals. The user selects the segmentation level for which they want the product mix determined.

With particular reference to FIG. 1B, a method 120 for determining a product mix for a retail store, according to a second embodiment of the present invention will now be discussed. In a first control block 102, the market segment is established. In a second control block 104, the market cutoff rate is established. In a third control block 106, the list of suggested product mix is generated. The method 120 includes the steps of determining an opportunity gap and producing a report. As shown in FIG. 1B, in a fourth control block 110, an opportunity gap is determined as a function of the sales information database. The opportunity gap represents potential sales of a product, service, or category, segment or sub-segment of a product or service that the retail store is not offering. For example, if the retail store provides 24 percent of the ACV in the market, yet is actually selling only 22 percent, there is a 3 percent opportunity gap. The opportunity gap further represents a profit opportunity. The program of the present invention establishes the ACV value and compares the ACV value with the account data, and for a particular category, segment or sub-segment or other segmentation level to determine the potential dollar sales of the selected segmentation level which is not currently carried by the retailer.

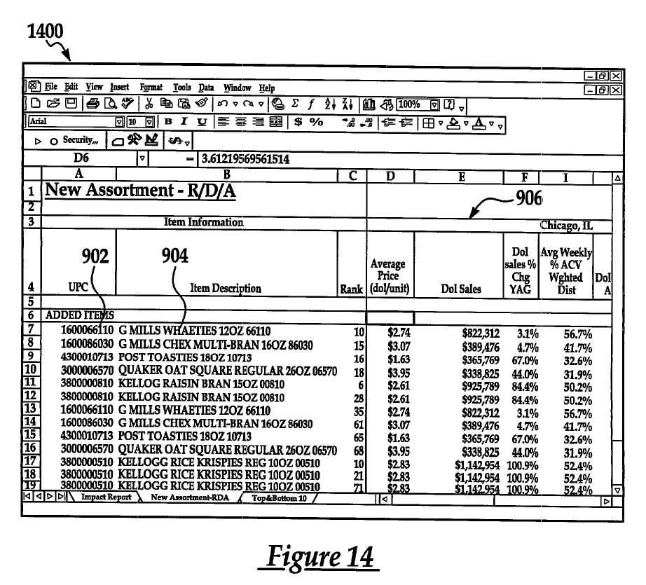

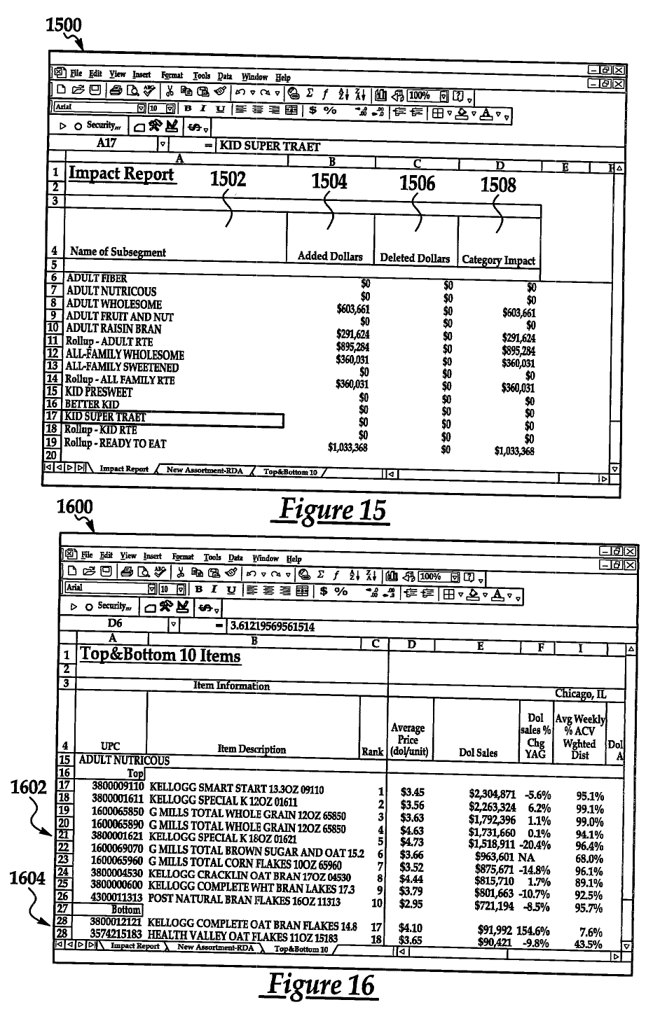

Referring to FIGS. 1B, 8 and 13 through 16, in a fifth control block 120, the method 120 further includes the step of producing a report including the list of suggested product mix. Examples of reports produced may be a new assortment report 1400, an impact report 1500, a top-bottom report 1600 or any other suitable report. A report 1400, 1500, 1600 may inform the retailer about the sales or profit history of the products or services currently provided or assist the retailer in making decisions as to products or services which should be offered to optimize sales. The format of the report, such as which columns of information to include, is user-driven. The report may include the same columns as are generated in a worksheet.

The new assortment report 1400 lists the products or services that should be provided by a retailer to optimize sales. The report may be produced by applying the market cutoff rate to the sales information database or any other suitable calculation. The new assortment report 1400 represents the suggestions regarding products or services which, if provided by the retailer, would allow the retailer to better serve their market for optimum sales. Referring to FIG. 13, in accordance with the new assortment report 1400, a user may make an assortment decision as to whether the amount carried of each product or service should be retained, deleted from or added to. The assortment decision may represent cumulative dollar sales, percentages or any other suitable method of measure for each product or service in the category, segment or sub-segment. In accordance with the new assortment report 1400, the retailer may make assortment decisions by choosing to retain, acid or delete the types or amounts of products or services provided in the retail store. As a result, the planogram of the retail store may be altered to reflect the assortment decision suggestions provided thereby creating a new assortment wherein lesser selling items are substituted for higher selling items across a market, category, segment or sub-segment.

The impact report 1500 includes the product or service 1502, amount added 1504, the amount deleted 1506 and an impact amount 1508. The impact amount 1506 allows the user to determine how an item that is added to or deleted from a planogram will impact the sales of another item such as a market, category 602, segment 604, 606 or sub-segment 608. This information assists a retailer in determining whether the expected sales warrant stocking that item at the retail store.

A top-bottom report 1600 lists the top ten items 1602 and bottom ten items 1604 for a market, category 602, segment 604, 606, or sub-segment 608. The top ten items 1602 are the items which should be added to optimize sales and the bottom ten items 1604 are the items which should be deleted from the planogram to optimize sales.

With particular reference to FIG. 1C, a method 130 for determining a product mix for a retail store, according to another embodiment of the present invention will now be discussed. In a first control block 102, the market segment is established. In a second control block 104, the market cutoff rate is established. In a third control block 106, the list of suggested product mix is generated. In a fourth control block 108, an opportunity gap is determined. In a fifth control block 110 a report is produced. In a sixth control block 112, the method 130 further includes the step of establishing the sales information database. In another control block 114, the method 130 further includes the step of establishing market conditions such as competitor information, demographic information, geographic information, inflation rate information, gross national product information or any other suitable information describing the market. The market conditions may be taken into account when producing a report to be discussed later.

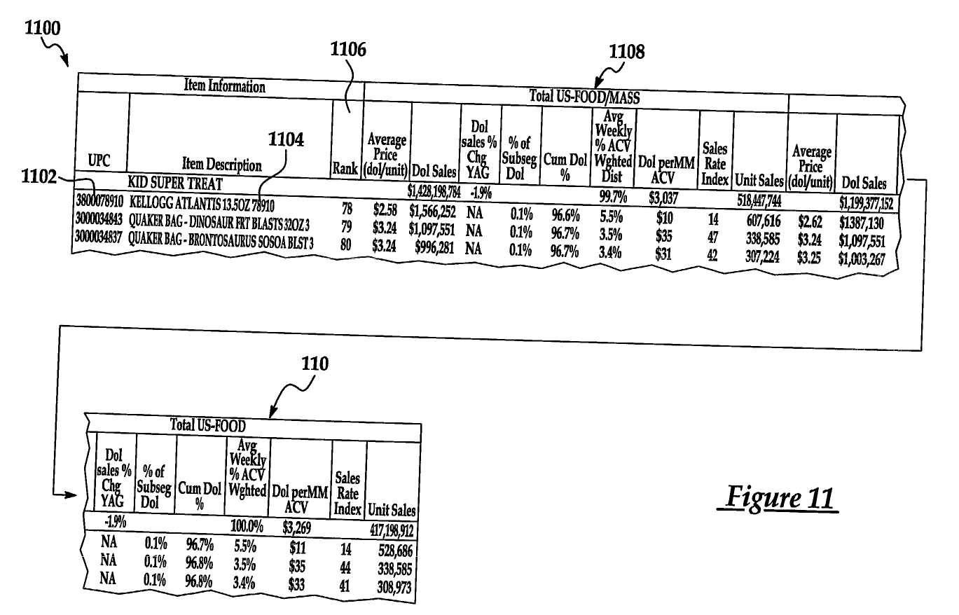

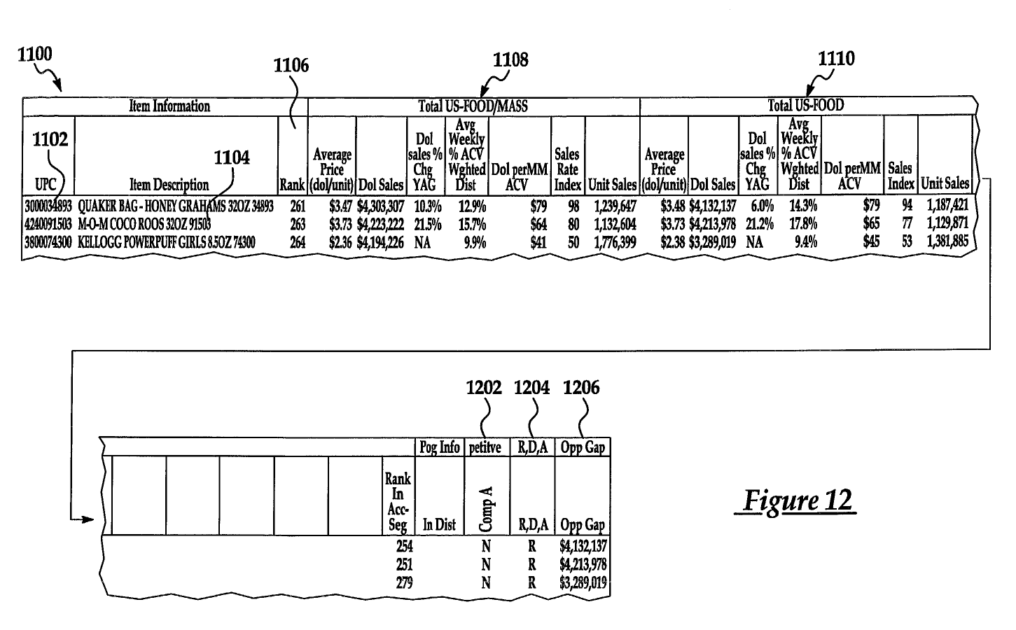

Referring to FIGS. 1C and 9 through 12, in yet another control block 116, the method 130 of the present invention further includes generating worksheets 900, 1000, 1100, 1200 as a function of the sales information database, the market segment and the market cutoff rate.

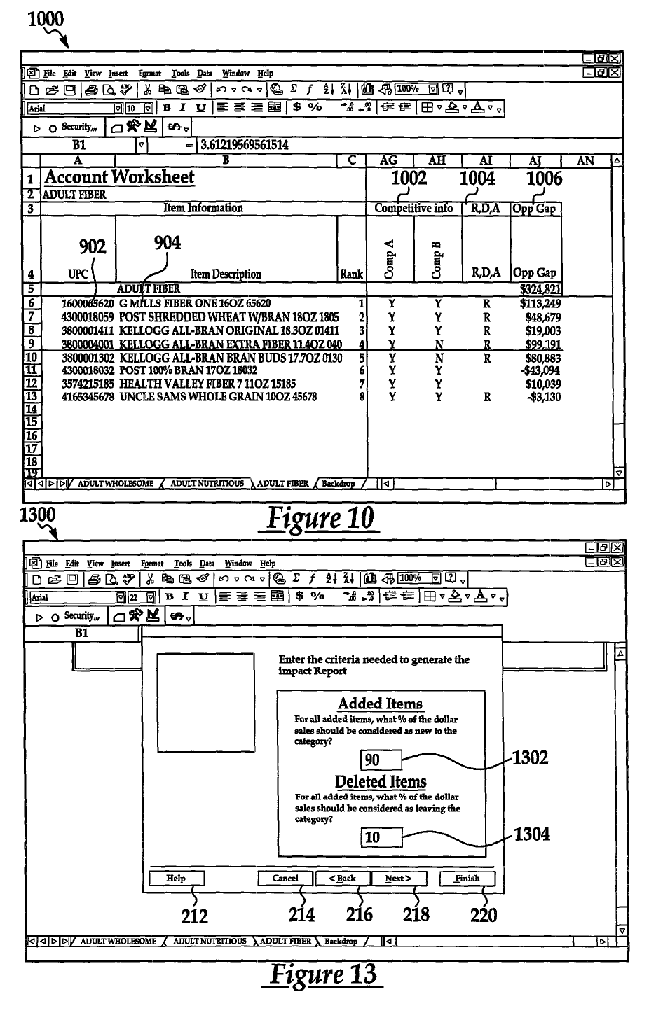

Referring to FIGS. 9 and 10, the worksheets 900, 1000, 1100, 1200 comprise the compiled information in a desired format determined by a user and permit the user to view the information in a format useful to the user. For example, the worksheet 1100, 1200 may be a category worksheet 1100, 1200 listing the UPC 1101, the product or service 1102, the ranking of the product in the assortment decision 1106, product sales and profit information for the retail store 1108, and product sales and profit information for a market 1110, competitor information 1202, assortment decisions 1204, the opportunity gap 1206 or any other suitable compilation of the data pertinent to the retailer's market. In addition, the worksheet 900, 1000 may be an account worksheet 900, 1000 having compiled therein an identifier 902, a description 904, sales 906, competitor information 1002, assortment decisions 1004, the opportunity gap 1006 or any suitable set of information pertinent to the retail store account and desirable to the user.

A worksheet 900, 1000, 1100, 1200 may be created for a sub-segment 608, segment 604, 606, category 602, market or any other suitable compilation of segmentation data. The format of the data compilation displayed in the worksheet 900, 1000, 1100, 1200 may take the form of percentages, dollars or any other suitable data compilation format. From these worksheets 900, 1000, 1100, 1200, assortment decisions may be made and reports may be generated.

In the preferred embodiment, the design for the program is based on the concept of a Wizard. A Wizard provides an automated and guided set of steps to help the user import a desired set of data to be integrated with steps allowing the user to enter the necessary criteria for composing product assortment reports. A means is provided for the user to progress both forward and backward through the process. Also, the user may cancel processing at any time.

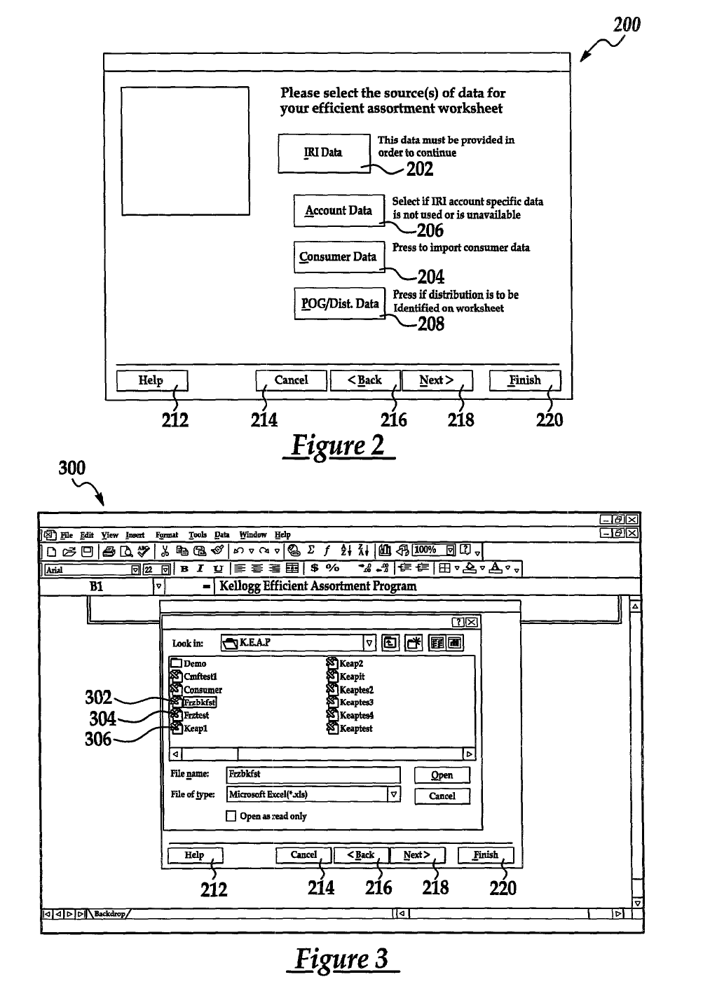

With reference to FIG. 2, an exemplary wizard interface is shown with the essential elements. Each step within the wizard provides the buttons shown including help, cancel, back, next and finish buttons 212, 214, 216, 218, 220. Each step may provide an appropriate title along with instructions for actions to be taken during the current task. A graphic may also be provided for each step in the wizard to improve user-friendliness and overall user acceptance. The graphics also relate to the current task at hand. Users of the present invention include manufacturers, service providers, suppliers, retailers or any other provider of products, services or other commodity wanting a report for determining the optimum mix of products, services or other commodities for maximizing sales.

In one aspect of the present invention, the method 100 is implemented in a computer software program. In one embodiment, the computer software program is executed on a stand-alone computer such as a personal computer or workstation. In one embodiment, computer files stored on the computer or located on removable media, such as compact discs, may contain the data used by the present invention. In another embodiment, the computer may be linked to another computer or computers over a computer network (such as a LAN or the Internet) to provide access to the data files.

In the illustrated embodiment, the computer software program is implemented within a spreadsheet program such as Microsoft Excel available from Microsoft Corporation of Redmond, Wash. The computer program may also be implemented within other commercially available software, e.g., a database application, such as Microsoft Access, also available from Microsoft Corporation. Alternatively, the computer software program may be implemented as ag standalone computer application.

Referring to FIGS. 2 through 8 and 13, operation of an embodiment of the present invention will now be discussed. Referring to FIGS. 2 and 3, a dialog box 200 database includes user buttons 202, 204, 206, 208 for selecting files to generate the sales information database. The user selects the desired data to be considered for generating a product mix, such as syndicated data, consumer panel data account files and planogram data. When the account file user button 206 is selected, the dialog box 300 opens displaying the existing account data files 302, 304, 306. Referring to FIG. 3, the dialog box 300 includes an Excel folder having several account data files 302, 304, 306. One or more of the account data files 302, 304, 306 may be imported to the computer program of the present invention when the user selects the desired files 302, 304, 306.

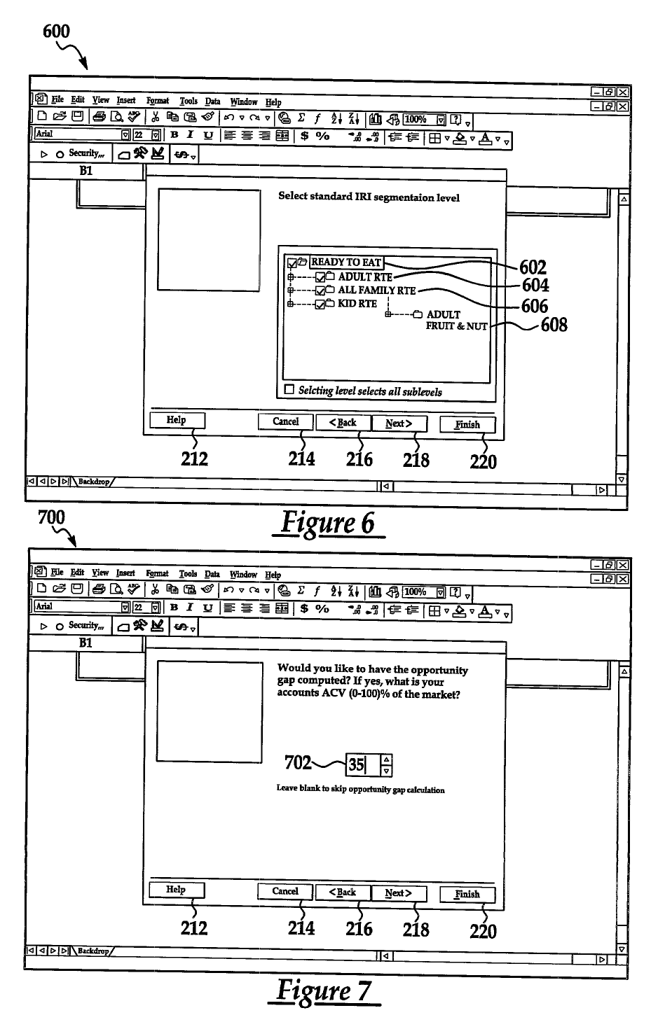

Referring to FIGS. 2 and 6, when the user selects the IRI user button 202, a dialog box 600 for selecting segmentation data is shown. In the preferred embodiment, the segmentation data is displayed as category 602, segment 604, 606 and sub-segments 608. The user may select the desired segmentation level to be included in the IRI data generating the sales information database which, in turn, is used for generating the list of suggested product mix, producing the reports 1400, 1500, 1600, generating the worksheets 900, 1000, 1100, 1200 or providing any other desired parameter.

Referring to FIG. 5, a dialog box 500 for inputting the market cutoff rate includes a dollar sales entry box 502 and a percent unit sales entry box 504. The user may enter the market cutoff rate as a percent of dollar sales or a percent of unit sales in the appropriate entry box 502, 504. The market cutoff rate entered may be used to produce reports, determine the opportunity gap or generate any other desired parameter.

Referring to FIG. 7, a dialog box 700 for entering an ACV value in an ACV entry box 702 to be used for determining the opportunity gap is shown. To determine the opportunity gap, the program establishes the ACV value and compares the ACV value with the account data, and for a particular category, segment or sub-segment or other segmentation level to determine the potential dollar sales of the selected segmentation level which is not currently carried by the retailer.

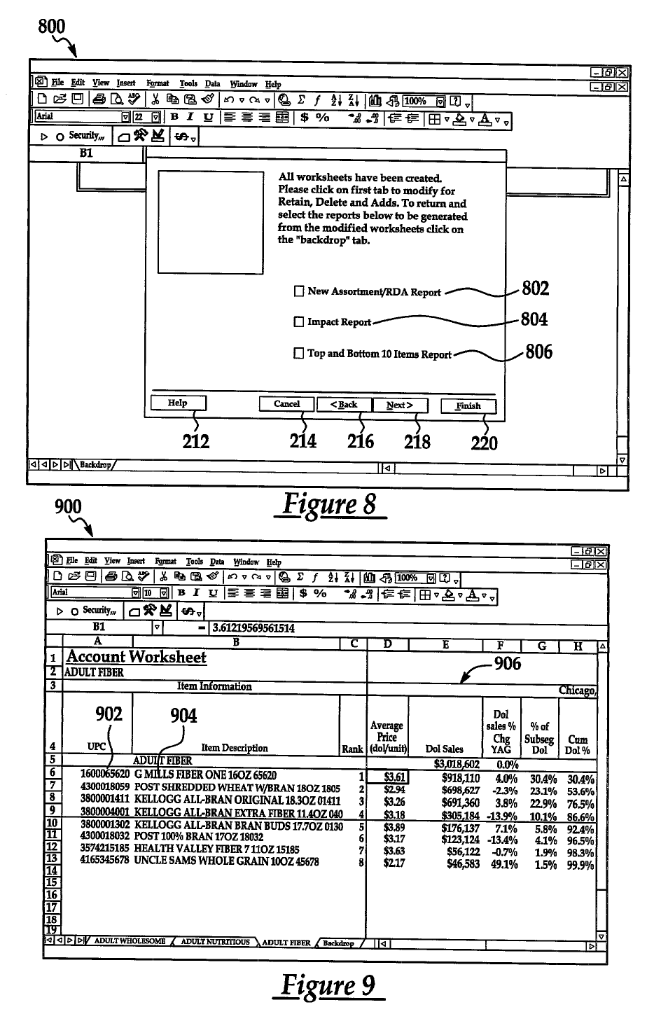

Referring to FIG. 8, dialog box 800 having user buttons 802, 804, 806 permits a user to select the reports 1400, 1500, 1600 to be produced by the computer program. In the preferred embodiment, the reports include the new assortment report 1400, the impact report 1500, and the top-bottom report 1600 as described herein.

Referring to FIG. 13, dialog box 1300 includes user buttons 1302, 1304. In accordance with the new assortment report 1400, a user may enter an assortment decision 1302, 1304 as to whether the amount carried of each product or service should be retained, deleted from or added to. Thus, the retailer may make assortment decisions by choosing to retain, add or delete the types or amounts of products or services provided in the retail store. The assortment decision 1032, 1304 may represent cumulative dollar sales, percentages or any other suitable method of measure for each product or service in the category 602, segment 604, 606 or sub-segment 608. Accordingly, reports 1400, 1500, 1600, worksheets 900, 1000, 1100, 1200 and opportunity gaps may be determined again based on the assortment decision.

The foregoing detailed description shows the preferred embodiments of the present invention are well suited to fulfill the objectives of the invention. It is recognized that those skilled in the art may make various modifications or additions to the preferred embodiments chosen herein to illustrate the present invention, without departing from the spirit of the present invention. Accordingly, it is to be understood that the subject matter sought to be afforded protection should be deemed to extend to the subject matter defined in the appended claims, including all equivalents thereof.

The invention has been described in an illustrative manner, and it is to be understood that the terminology that has been used is intended to be in the nature of words of description rather than limitation. It will be apparent to those skilled in the art that many modifications and variations of the present invention are possible in light of the above teachings. Therefore, it is to be understood that the invention may be practiced otherwise than as specifically described within the scope of the amended claims.

What is claimed is:

1. A computer-based method for determining a product mix for a retail store, including the steps of:
establishing a market segment;
establishing a market cutoff rate; and
generating a list of suggested product mix as a function of the market segment, the market cutoff rate and a sales information database having information related to sales of product as a function of time.

2. A method, as set forth in claim 1, wherein the sales information database includes syndicated data.

3. A method, as set forth in claim 1, wherein the sales information database includes consumer panel data.

4. A method, as set forth in claim 1, wherein the sales information database includes planogram data.

5. A method, as set forth in claim 1, wherein the sales information database includes account data associated with the retail store.

6. A method, as set forth in claim 5, wherein retail store account data includes an identifier, description data and dollar sales data.

7. A method, as set forth in claim 6, wherein the product identifier is a universal product code (“UPC”)

8. A method, as set forth in claim 5, wherein the retail store account data includes all commodity volume (“ACV”) weighted distribution data.

9. A method, as set forth in claim 8, wherein the ACV data includes ACV weighted distribution data.

10. A method, as set forth in claim 8, wherein the ACV data includes dollars per million ACV data.

11. A method, as set forth in claim 5, wherein the retail store account data includes segmentation data.

12. A method, as set forth in claim 11, wherein the segmentation data includes category data, segment data and sub-segment data.

13. A method as set forth in claim 1 including the step of determining an opportunity gap as a function of the sales information database.

14. A method, as set forth in claim 1, including the step of producing a report including the list of suggested product mix.

15. A method, as set forth in claim 14, wherein the report is a new assortment report.

16. A method as set forth in claim 14 wherein the report is an impact report.

17. A method, as set forth in claim 14, wherein the report is a top-bottom report.

18. A method, as set forth in claim 1, including the steps of establishing data changes and producing a report as a function of the data changes and including the list of suggested product mix.

19. A computer-based method for producing a report for product mix for a retail store, including the steps of:
establishing a market segment;
establishing a market cutoff rate;
generating a list of suggested product mix as a function of the market segment, the market cutoff rate and a sales information database;
determining an opportunity gap as a function of the sales information database; and
producing a report including the list of suggested product mix.

20. A method, as set forth in claim 19, wherein the report is a new assortment report.

21. A method, as set forth in claim 19, wherein the report is an impact report.

22. A method, as set forth in claim 19, wherein the report is a top-bottom report.

23. A method as set forth in claim 19 including the steps of establishing assortment decisions and producing a report as a function of the data changes and including the list of suggested product mix.

24. A computer-based method for determining a product mix for a retail store, including the steps of:
establishing a market segment;
establishing a market cutoff rate;
establishing a sales information database;
establishing market conditions;
generating worksheets as a function of the sales information database, the market segment and the market cutoff rate;
generating a list of suggested product mix as a function of the market segment, the market cutoff rate, the sales information database, and the marketing conditions;
determining an opportunity gap as a function of the sales information database; and
producing a report including the list of suggested product mix.

25. A method, as set forth in claim 24, wherein the report is a new assortment report.

26. A method, as set forth in claim 24, wherein the report is an impact report.

27. A method, as set forth in claim 24, wherein the report is a top-bottom report.
